(19) United States
(12) Patent Application Publication
(10) Pub. No.: US 2026/0353211 A1
(43) Pub. Date: Nov. 5, 2026

(54) SCELL MEASUREMENT METHOD AND APPARATUS, TERMINAL, AND NETWORK SIDE DEVICE

(71) Applicant: VIVO MOBILE COMMUNICATION CO., LTD., Dongguan (CN)

(72) Inventors: Xusheng WEI, Dongguan (CN); Yanliang SUN, Dongguan (CN); Qian YANG, Dongguan (CN)

(21) Appl. No.: 19/727,393

(22) Filed: Jul. 1, 2026

Related U.S. Application Data
(63) Continuation of application No. PCT/CN2025/070543, filed on Jan. 3, 2025.

(30) Foreign Application Priority Data
Jan. 4, 2024 (CN) 202410017643.0

(51) Int. Cl. H04W 36/00

(52) U.S. Cl. CPC H04W 36/0085; H04W 36/0058

(57) ABSTRACT

An Scell measurement method and apparatus, a terminal, and a network side device are disclosed in the field of wireless communication technologies. The Scell measurement method in embodiments of this application includes a terminal performing L1 measurement on a first frequency of a first Scell and the terminal performing L3 measurement on a second frequency of the first Scell. The first frequency and the second frequency are respectively associated with a same target physical frequency of the first Scell, and the target physical frequency is simultaneously configured with the L1 measurement and the L3 measurement.

### CROSS-REFERENCE TO RELATED APPLICATIONS

This application is a bypass continuation application of International Application No. PCT/CN2025/070543, filed on Jan. 3, 2025, which claims the benefit of and priority to Chinese Patent Application No. 202410017643.0, filed on Jan. 4, 2024, the contents of both of which being incorporated by reference in their entireties herein as part of this application.

### TECHNICAL FIELD

This application relates to the field of wireless communication technologies and, in particular, to an Scell measurement method and apparatus, a terminal, and a network side device.

### BACKGROUND

Low-layer triggered mobility (LTM) management technology supports a cell change directly triggered based on a beam management result. The LTM technology requires a terminal, for example, a user equipment (UE), to more accurately and rapidly collect beam information of a source cell and a target cell, that is, to perform Layer 1 (L1) measurement, then perform a measurement result comparison, and complete L1 reporting.

### SUMMARY

According to a first aspect, an Scell measurement method is provided, and is performed by a terminal. The method includes:
performing, by a terminal, Layer 1 (L1) measurement on a first frequency of a first Scell; and
performing, by the terminal, Layer 3 (L3) measurement on a second frequency of the first Scell.

The first frequency and the second frequency are respectively associated with a same target physical frequency of the first Scell, and the target physical frequency is simultaneously configured with the L1 measurement and the L3 measurement.

According to a second aspect, an Scell measurement method is provided, and is performed by a network side device. The method includes:
sending, by the network side device, configuration information to a terminal, where the configuration information includes at least one of the following:
a first frequency of a first Scell used for Layer 1 (L1) measurement; or
a second frequency of the first Scell used for Layer 3 (L3) measurement.

The first frequency and the second frequency are respectively associated with a same target physical frequency of the first Scell, and the target physical frequency is simultaneously configured with the L1 measurement and the L3 measurement.

According to a third aspect, an Scell measurement apparatus is provided, including:
a first measurement module, configured to perform Layer 1 (L1) measurement on a first frequency of a first Scell; and
a second measurement module, configured to perform Layer 3 (L3) measurement on a second frequency of the first Scell.

The first frequency and the second frequency are respectively associated with a same target physical frequency of the first Scell, and the target physical frequency is simultaneously configured with the L1 measurement and the L3 measurement.

According to a fourth aspect, an Scell measurement apparatus is provided, including:
a second sending module, configured to send configuration information to a terminal, where the configuration information includes at least one of the following:
a first frequency of a first Scell used for Layer 1 (L1) measurement; or
a second frequency of the first Scell used for Layer 3 (L3) measurement.

The first frequency and the second frequency are respectively associated with a same target physical frequency of the first Scell, and the target physical frequency is simultaneously configured with the L1 measurement and the L3 measurement.

According to a fifth aspect, a terminal is provided. The terminal includes a processor and a memory. The memory stores a program or instructions executable in the processor. The program or the instructions, when executed by the processor, implement the steps of the method according to the first aspect.

According to a sixth aspect, a terminal is provided, including a processor and a communication interface. The processor is configured to:
perform Layer 1 (L1) measurement on a first frequency of a first Scell; and
perform Layer 3 (L3) measurement on a second frequency of the first Scell.

The first frequency and the second frequency are respectively associated with a same target physical frequency of the first Scell, and the target physical frequency is simultaneously configured with the L1 measurement and the L3 measurement.

According to a seventh aspect, a network side device is provided. The network side device includes a processor and a memory. The memory stores a program or instructions executable in the processor. The program or the instructions, when executed by the processor, implement the steps of the method according to the second aspect.

According to an eighth aspect, a network side device is provided, including a processor and a communication interface. The communication interface is configured to send configuration information to a terminal, where the configuration information includes at least one of the following:
a first frequency of a first Scell used for Layer 1 (L1) measurement; or
a second frequency of the first Scell used for Layer 3 (L3) measurement.

The first frequency and the second frequency are respectively associated with a same target physical frequency of the first Scell, and the target physical frequency is simultaneously configured with the L1 measurement and the L3 measurement.

According to a ninth aspect, a readable storage medium is provided. The readable storage medium stores a program or instructions. The program or the instructions, when executed by a processor, implement the steps of the method according to the first aspect, or implement the steps of the method according to the second aspect.

According to a tenth aspect, a wireless communication system is provided, including a terminal and a network side device. The terminal may be configured to perform the steps of the method according to the first aspect. The network side device may be configured to perform the steps of the method according to the second aspect.

According to an eleventh aspect, a chip is provided. The chip includes a processor and a communication interface. The communication interface is coupled to the processor. The processor is configured to run a program or instructions to implement the method according to the first aspect, or implement the method according to the second aspect.

According to a twelfth aspect, a computer program/program product is provided. The computer program/program product is stored in a storage medium. The computer program/program product is executed by at least one processor to implement the steps of the method according to the first aspect, or implement the steps of the method according to the second aspect.

### BRIEF DESCRIPTION OF THE DRAWINGS

FIG. 1 is a block diagram of a wireless communication system to which an embodiment of this application may be applied;

FIG. 2 is a schematic flowchart 1 of an Scell measurement method according to an embodiment of this application;

FIG. 3 is a schematic flowchart 2 of an Scell measurement method according to an embodiment of this application;

FIG. 4 is a schematic structural diagram 1 of an Scell measurement apparatus according to an embodiment of this application;

FIG. 5 is a schematic structural diagram 2 of an Scell measurement apparatus according to an embodiment of this application;

FIG. 6 is a schematic structural diagram of a communication device according to an embodiment of this application;

FIG. 7 is a schematic diagram of a hardware structure of a terminal according to an embodiment of this application; and

FIG. 8 is a schematic diagram of a hardware structure of a network side device according to an embodiment of this application.

### DETAILED DESCRIPTION

Technical solutions in embodiments of this application are clearly described below with reference to accompanying drawings in embodiments of this application. Understandably, the described embodiments are merely some rather than all embodiments of this application. All other embodiments obtained by a person of ordinary skill in the art based on embodiments of this application fall within the protection scope of this application.

Terms “first”, “second”, and the like in this application are used to distinguish between similar objects rather than describe a specific order or sequence. It should be understood that the terms used in this way may be transposed where appropriate, so that embodiments of this application can be implemented in a sequence other than those illustrated or described herein. In addition, objects distinguished by “first” and “second” are generally of the same class and do not limit a quantity of objects. For example, one or more first objects may be arranged. In addition, “or” in this application indicates at least one of connected objects. For example, “A or B” encompasses three solutions: solution 1: A is included, but B is not included; solution 2: B is included, but A is not included; and solution 3: both A and B are included. The character “/” generally indicates an “or” relationship between associated objects.

A term “indication” in this application may be a direct indication (or an explicit indication) or an indirect indication (or an implicit indication). The direct indication may be understood as that a sending party clearly informs a receiving party of content such as specific information, an operation that needs to be performed, or a request result in the sent indication. The indirect indication may be understood as that the receiving party determines corresponding information based on an indication sent by the sending party, or makes a determination and determines, based on a determining result, an operation that needs to be performed or a request result.

It should be noted that the technology described in embodiments of this application may be applied to a long term evolution (LTE)/LTE-advanced (LTE-A) system, and may be further applied to another wireless communication system, such as a code division multiple access (CDMA) system, a time division multiple access (TDMA) system, a frequency division multiple access (FDMA) system, an orthogonal frequency division multiple access (OFDMA) system, a single-carrier frequency-division multiple access (SC-FDMA) system, or another system. Terms “system” and “network” in embodiments of this application are usually used interchangeably, and the described technology may be used for both the system and the radio technology mentioned above, or may be used for another system and another radio technology. A new radio (NR) system is described below for an illustrative purpose, and the term NR is used in most of the following descriptions. Nevertheless, the technologies may also be applied to a system other than the NR system, such as a 6th generation (6G) communication system.

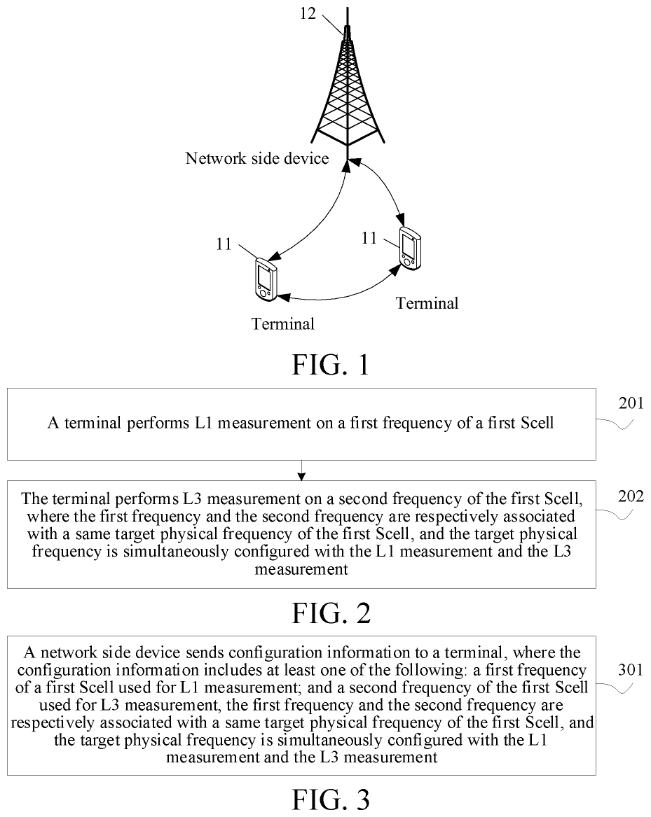

FIG. 1 is a block diagram of a wireless communication system to which an embodiment of this application may be applied. The wireless communication system includes a terminal 11 and a network side device 12. The terminal 11 may be a terminal side device such as a mobile phone, a tablet computer (Tablet Personal Computer), a laptop computer, a notebook computer, a personal digital assistant (PDA), a palmtop computer, a netbook, an ultra-mobile personal computer (UMPC), a mobile internet device (MID), augmented reality (AR), a virtual reality (VR) device, a robot, a wearable device, a flight vehicle, an on-board device (Vehicle User Equipment, VUE), a shipborne device, a pedestrian terminal (Pedestrian User Equipment, PUE), a smart home appliance (a home device with a wireless communication capability, such as a refrigerator, a television, a washing machine, or furniture), a game console, a personal computer (PC), a teller machine, or a self-service machine. The wearable device includes a smart watch, a smart bracelet, a smart headset, smart glasses, smart jewelry (a smart bracelet, a smart chain bracelet, a smart ring, a smart necklace, a smart ankle bangle, a smart ankle chain, and the like), a smart wristband, smart clothing, and the like. The on-board device may also be referred to as an on-board terminal, a vehicle on-board controller, an on-board module, an on-board component, an on-board chip, an on-board unit, or the like. It should be noted that, a specific type of the terminal 11 is not limited in embodiments of this application. The network side device 12 may include an access network device or a core network device. The access network device may also be referred to as a radio access network (RAN) device, a wireless access network function, or a wireless access network unit. The access network device may include a base station, a wireless local area network (WLAN) access point (AP), a wireless fidelity (Wi-Fi) node, or the like. The base station may be referred to as a node B (NB), an evolved Node B (eNB), a next generation Node B (the next generation Node B, gNB), a new radio Node B (NR Node B), an access point, a relay base station (RBS), a serving base station (SBS), a base transceiver station (BTS), a radio base station, a radio transceiver, a basic service set (BSS), an extended service set (ESS), a home node B HNB), a home evolved node B, a transmission reception point (TRP), or another appropriate term in the art. The base station is not limited to a specific technical term, as long as the same technical effect can be achieved. It should be noted that, in embodiments of this application, only a base station in an NR system is used as an example for description, and a specific type of the base station is not limited.

To facilitate a clearer understanding of the technical solutions provided in embodiments of this application, some related knowledge is first described below.

In conventional radio resource management (RRM) measurement, Layer 3 (L3) measurement and Layer 1 (L1) measurement are included. A UE needs to report an L3 result to a base station based on the L3 measurement. Then, the base station indicates and implements a cell change (which broadly refers to handover, redirection, secondary cell loading/activation, primary and secondary cell loading/activation, and the like herein) based on the L3 measurement result. In this process or after the process is completed, the base station may further deliver an L1 measurement configuration on the cell as needed, to indicate the UE to perform the L1 measurement. In a conventional sense, the L1 measurement is mainly used for beam management.

Because large-scale antenna array technology exists in the 5th generation mobile communication (5G), operations such as beam management are defined in the 5G standard. A network needs to configure the UE for performing the L1 measurement, and determine an optimal uplink and downlink beam pairing based on L1 reporting after the UE completes the measurement, thereby reaching a theoretical performance limit. In this process, to some extent, a plurality of rounds of information collection and interaction need to be performed between the network and the UE in a cell change process, to reach the theoretical performance limit. The plurality of rounds of information collection and interaction usually require a relatively long time. Therefore, in a medium to high speed movement state, when UE handover occurs frequently, the UE often cannot reach the performance limit in most of cells the UE passes through, causing loss of spectrum efficiency and loss of user experience.

To shorten duration of information interaction between the base station and the UE, a key means for improving performance is to perform link establishment on a target cell in advance before the handover, that is, to complete a beam management process in advance, while minimizing an interruption to real-time communication with a source cell in this process.

When a system configures the L1 measurement for the target cell, similar to the L3 measurement, the system may further configure intra-frequency or inter-frequency L1 measurement for a deactivated SCell. If the configured L1 measurement is outside a current activated BWP (Bandwidth Part), the UE needs a measurement gap (gap) to perform the configured L1 measurement. Generally, the system configures a plurality of measurement objects for the UE, and some of the measurement objects requiring to use the measurement gap need to share the measurement gap configured by the system.

For a scenario in which a certain deactivated Scell is simultaneously configured with the L1 measurement and the L3 measurement, a measurement requirement corresponding to the L3 may be based on a current performance indicator of the L3 measurement of the deactivated SCell. However, due to existence of the L1 measurement, the current L3 performance measurement indicator may be significantly optimized. In addition, a measurement requirement of the L1 also needs to be clearly defined.

However, for a deactivated secondary cell (SCell), if the L1 measurement and Layer 3 (L3) measurement are simultaneously configured, how to implement the L1 measurement and the L3 measurement is a technical problem to be urgently resolved.

That is, for the deactivated SCell, if the L1 measurement and the L3 measurement are simultaneously configured, a measurement delay of the L3 measurement is relatively large when the current performance indicator is followed. Because the L1 measurement is configured, frequent L1 measurement prevents a terminal from entering deep sleep, resulting in a relatively low power saving gain (power saving gain) of the terminal. Therefore, a new measurement method is needed to resolve the problem. In addition, while reducing the delay, use of the new method may also affect a terminal interruption, and a corresponding solution is further needed. Based on the new method, a performance indicator of the L1 measurement of the deactivated SCell also needs to be determined.

To resolve the technical problem existing in the prior art, embodiments of this application provide an Scell measurement method and apparatus, a terminal, and a network side device.

An Scell measurement method and apparatus, a terminal, and a network side device provided in embodiments of this application are described in detail below through some embodiments and application scenarios thereof with reference to accompany drawings.

FIG. 2 is a schematic flowchart 1 of an Scell measurement method according to an embodiment of this application. The method is applied to a terminal. As shown in FIG. 2, the method includes step 201 and step 202.

Step 201: A terminal performs L1 measurement on a first frequency of a first Scell.

Step 202: The terminal performs L3 measurement on a second frequency of the first Scell.

The first frequency and the second frequency are respectively associated with a same target physical frequency of the first Scell, and the target physical frequency is simultaneously configured with the L1 measurement and the L3 measurement.

Optionally, the first Scell may include at least one of the following: a deactivated Scell; a dormant Scell; or a specific Scell.

For example, when the first Scell is in a deactivated state or a dormant state, if the same target physical frequency of the first Scell is simultaneously configured with the L1 measurement and the L3 measurement, for the target physical frequency, in embodiments of this application, the L1 is used as the first frequency of the first Scell, the L3 is used as the second frequency of the first Scell, and both the first frequency and the second frequency are associated with the target physical frequency. In other words, the L1 and the L3 are respectively processed as one logical frequency. The terminal performs the L1 measurement on the first frequency and performs the L3 measurement on the second frequency.

Optionally, a network side device sends configuration information to the terminal, where the configuration information includes at least one of the following:
1) the first frequency used for the L1 measurement; or
2) the second frequency used for the L3 measurement.

Optionally, the configuration information further includes indication information, and the indication information indicates that the first frequency and the second frequency are respectively associated with the target physical frequency.

After receiving the configuration information from the network side device, the terminal performs the L1 measurement on the first frequency of the first Scell and performs the L3 measurement on the second frequency of the first Scell based on the configuration information.

In embodiments of this application, the same target physical frequency of the first Scell is simultaneously configured with the L1 measurement and the L3 measurement. For the target physical frequency, the L1 is used as the first frequency of the first Scell, the L3 is used as the second frequency of the first Scell, and both the first frequency and the second frequency are associated with the target physical frequency. In other words, the L1 and the L3 are respectively processed as one logical frequency. The terminal performs the L1 measurement on the first frequency and performs the L3 measurement on the second frequency, thereby implementing the L1 measurement and the L3 measurement on the first SCell on which the L1 measurement and the L3 measurement are simultaneously configured.

Optionally, the terminal receives a measurement request from the network side device, and the measurement request indicates the terminal to perform the L1 measurement and the L3 measurement. Then, the terminal triggers the L1 measurement and the L3 measurement based on the measurement request.

Optionally, the terminal reports an L1 measurement result to the network side device based on the L1 measurement, and the terminal reports an L3 measurement result to the network side device based on the L3 measurement.

Optionally, a performance indicator of the L1 measurement includes a first scaling factor (scaling factor), and/or a performance indicator of the L3 measurement includes a second scaling factor.

To determine a longest measurement time for the L1 measurement and a longest measurement time for the L3 measurement, the first scaling factor in the performance indicator of the L1 measurement and the second scaling factor in the performance indicator of the L3 measurement are first calculated. Then, the longest measurement time for the L1 measurement is determined based on the first scaling factor, and the longest measurement time for the L3 measurement is determined based on the second scaling factor.

The longest measurement time refers to a maximum time allowed for completing corresponding cell discovery and cell measurement when the terminal performs the L1/L3 measurement on the corresponding frequency, and is a boundary condition that needs to be considered when a relevant measurement process processing module performs internal processing. It should be noted that, the terminal may not always complete the corresponding measurement based on the maximum measurement time. In other words, the terminal may complete the measurement in advance.

Optionally, the first scaling factor and the second scaling factor are determined based on at least one of the following.

Case 1: For a case in which measurement of an L1 frequency (that is, the first frequency) requires a gap and measurement of an L3 frequency (that is, the second frequency) does not require the gap, the first scaling factor is determined based on a carrier-specific scaling factor (CSSF) within a gap (CSSF_{within_gap,i}), and the second scaling factor is determined based on a CSSF outside the gap (CSSF_{outside_gap,i}). Herein, i represents a measurement object (MO).

The longest measurement time for the L1/L3 measurement is calculated based on the following method: The first scaling factor in the performance indicator of the L1 measurement is calculated in the CSSF_{within_gap,i}. The second scaling factor in the performance indicator of the L3 measurement is considered in the CSSF_{outside_gap,i}. Then, the longest measurement time for the L1 measurement is determined based on the first scaling factor, and the longest measurement time for the L3 measurement is determined based on the second scaling factor.

Case 2: For a case in which the measurement of the L1 frequency (that is, the first frequency) does not require the gap and the measurement of the L3 frequency (that is, the second frequency) requires the gap, the first scaling factor is determined based on the CSSF_{outside_gap,i}, and the second scaling factor is determined based on the CSSF_{within_gap,i}.

Case 3: For a case in which the measurement of both the L1 frequency (that is, the first frequency) and the L3 frequency (that is, the second frequency) requires the gap, the first scaling factor is determined based on the CSSF_{within_gap,i}, and the second scaling factor is determined based on the CSSF_{within_gap,i}.

The longest measurement time for the L1/L3 measurement is calculated based on the following method: The first scaling factor in the performance indicator of the L1 measurement is determined based on the CSSF_{within_gap,i}, and the second scaling factor in the performance indicator of the L3 measurement is determined based on the CSSF_{within_gap,i}. Then, the longest measurement time for the L1 measurement is determined based on the first scaling factor, and the longest measurement time for the L3 measurement is determined based on the second scaling factor.

If reference signal cycles for the L1 measurement and the L3 measurement are completely the same, the two, when calculating the CSSF_{within_gap,i}, may be combined, that is, being considered as one frequency layer for calculation. In this scenario, for a frequency range 2 (FR2), time division measurement for the L3 measurement and the L1 measurement needs to be performed. When the longest measurement time is determined, a time division-based shared measurement factor between the L1 and the L3 further needs to be considered.

Case 4: For a case in which the measurement of both the L1 frequency (that is, the first frequency) and the L3 frequency (that is, the second frequency) does not require the gap, the first scaling factor is determined based on the CSSF_{outside_gap,i}, and the second scaling factor is determined based on the CSSF_{outside_gap,i}.

Optionally, for a certain deactivated SCell frequency, if the frequency is simultaneously configured with inter-frequency L1 and inter-frequency L3 measurement, the L1 and the L3 are respectively processed as one (logical) frequency. For a case in which the L1 measurement requires the gap, the L3 measurement may be performed within the gap or outside the gap in this case. The first scaling factor is determined based on CSSF_{within_gap,i}, and the L1 measurement is used as a candidate object for measurement within a target gap. In other words, the L1 measurement needs to be added to the candidate object using the target gap.

Optionally, for a case in which the measurement of the L1 frequency does not require the gap, the L3 measurement may be performed within the gap or outside the gap in this case. The first scaling factor is determined based on the CSSF outside the gap, and the L1 measurement is used as a candidate object for measurement outside the target gap. The L1 measurement is considered in CSSF_{outside_gap,i}, which may be specifically the following examples.

For a case in which inter-frequency L1 measurement does not require the gap, CSSF_{outside_gap,i} may be calculated by using the following equations.
1) For a scenario of frequency range 1 only carrier aggregation (FR1 only CA), CSSF_{outside_gap,i}=N_{SCC_SSB}+Y+2×N_{SCC_CSIRS}+N_{SCC_L1}.
2) For a scenario of FR2 only intra band carrier aggregation (FR2 only intra band CA), CSSF_{outside_gap,i}=N_{SCC_SB}+Y+2×N_{SCC_CSIRS}+N_{SCC_L1}.
3) For a scenario of FR2 only inter band carrier aggregation (FR2 only inter band CA), CSSF_{outside_gap,i}=2× (N_{SCC_SSB}+Y+2×N_{SCC_CSIRS}−1−N_{SCC_CSIRS_FR2_NCM})+N_{SCC_L1}.
4) For a scenario of FR1+FR2 CA (FR1 primary cell (Primary cell, Pcell)), CSSF_{outside_gap,i}=2× (N_{SCC_SSB}+Y+2×N_{SCC_CSIRS}−1−N_{SCC_CSIRS_FR2_NCM})+N_{SCC_L1}.
5) For a scenario of FR1+FR2 CA (FR2 PCell), CSSF_{outside_gap,i}=N_{SCC_SSB}+Y+2×N_{SCC_CSIRS}+N_{SCC_L1}.

N_{SCC_L1} is a number of inter-frequency L1 measurement outside the gap (for example, the number of configured inter-frequency L1 measurement without MG that are being measured outside of MG).

N_{SCC_SSB} is a number of SCells configured with SSB-based L3 measurement (for example, Number of configured SCell(s) with only SSB based L3 measurement configured, which is measured without MG).

Y is a number of inter-frequency measurement objects (MO) measured outside the gap (for example, the number of configured inter-frequency MOs without MG that are being measured outside of MG; otherwise, it is 0).

N_{SCC_CSIRS} is a number of SCells configured with both SSB-based and channel state information reference signal (CSI-RS) based L3 measurement or SCells configured with only CSI-RS based L3 measurement (for example, Number of configured SCell(s) with either both SSB and CSI-RS based L3 measurement configured or only CSI-RS based L3 measurement configured).

N_{SCC_CSIRS_FR2_NCM} is equal to 1 when an FR2 secondary component carrier (SCC) (where neighboring cell measurement is required) is configured with the SSB and the CSI-RS or configured with only the CSI-RS measurement; otherwise, it is equal to 0 (for example, 1 if FR2 SCC, where neighbour cell measurement is required, is with either both SSB and CSI-RS configured or only CSI-RS measurement configured; otherwise, N_{SCC_CSIRS_FR2_NCM}=0).

Optionally, the gap used for the L1 measurement and/or the L3 measurement is mainly a network controlled small gap (NCSG). For the L1 measurement, or when the L1 measurement and the L3 measurement are simultaneously configured, whether the gap is required may be notified to the network side device in a capability reporting manner.

The terminal sends capability information to the network side device. The capability information includes at least one of the following.
1) The L1 measurement requires a gap.

It should be noted that, ‘the L1 measurement requires a gap’ means that for the L1 measurement, the terminal reports the capability information to the frequency layer of the first Scell, to indicate that the terminal needs the network to configure a corresponding gap when performing the L1 measurement on the deactivated/dormant SCell or the neighboring cell.
2) The L1 measurement requires a network controlled small gap NCSG.
3) The L1 measurement does not require a gap.

It should be noted that, ‘the L1 measurement does not require a gap’ means that for the L1 measurement, the terminal reports the capability information to the frequency layer of the first Scell, to indicate that the terminal does not need a measurement gap when performing the L1 measurement on the deactivated/dormant SCell or the neighboring cell. For example, the terminal reports “nogap-noncsg” through NeedforNCSG.

Optionally, when ‘the L1 measurement does not require a gap’, the terminal may not report the capability information, to implicitly indicate that the terminal does not need the measurement gap when performing the L1 measurement on the deactivated/dormant SCell or the neighboring cell.
4) The L3 measurement requires a gap.
5) The L3 measurement requires an NCSG.
6) The L3 measurement does not require a gap.

It should be noted that, ‘the L3 measurement does not require a gap’ means that for the L3 measurement, the terminal reports the capability information to the frequency layer of the first Scell, to indicate that the terminal does not need the measurement gap when performing the L3 measurement on the deactivated/dormant SCell or the neighboring cell. For example, the terminal reports “nogap-noncsg” through NeedforNCSG.

Optionally, the capability information occupies one information field, and indicates that the L1 measurement and the L3 measurement simultaneously satisfy any one of the following: requiring the gap, requiring the NCSG, or not requiring the gap. That is, one single field indicates a gap requirement of both the L1 measurement and the L3 measurement (both requiring the gap, both requiring the NCSG, or neither requiring the gap).

Alternatively, the capability information occupies two information fields, and respectively indicates whether the L1 measurement and the L3 measurement each require the gap.

For example, if whether the L1 measurement and the L3 measurement each require the gap is respectively indicated through 2 fields for the L1 measurement and the L3 measurement on the deactivated SCell, the following example may be used for signaling:

| | |
|---|---|
| NeedForGapNCSG-InfoNR-r17 ::= | SEQUENCE { |
| intraFreq-needForNCSG-r17 | NeedForNCSG-IntraFreqList-r17, |
| interFreq-needForNCSG-r17 | NeedForNCSG-BandListNR-r17 |
| intraFreq-needForNCSG-L1 | NeedForNCSG-IntraFreqList-r17, |
| interFreq-needForNCSG-L1 | NeedForNCSG-BandListNR-r17 |

```
  }
  NeedForNCSG-IntraFreqList-r17::=SEQUENCE (SIZE (1.. maxNrofServingCells)) OF
NeedForNCSG-IntraFreq-r17
  NeedForNCSG-BandListNR-r17::=SEQUENCE  (SIZE  (1..maxBands) OF
NeedForNCSG-NR-r17
  NeedForNCSG-IntraFreqList-L1::=SEQUENCE (SIZE (1.. maxNrofServingCells)) OF
NeedForNCSG-IntraFreq-r17
  NeedForNCSG-BandListNR-L1::=SEQUENCE  (SIZE  (1..maxBands) OF
  NeedForNCSG-IntraFreq-r17::=SEQUENCE {
```

| | |
|---|---|
| servCellId-r17 | ServCellIndex, |
| gapIndicationIntra-r17 | ENUMERATED {gap, ncsg, nogap-noncsg} |
| } | |
| NeedForNCSG-NR-r17::= | SEQUENCE { |
| bandNR-r17 | FreqBandIndicatorNR, |
| gapIndication-r17 | ENUMERATED {gap, ncsg, nogap-noncsg} |
| }. | |

In the prior art, determination of the longest measurement time for the L3 measurement of the deactivated first Scell depends on a value of a measurement cycle (measCycleSCell). An objective of introducing the value is to provide relatively sufficient time for the terminal, so that the terminal enters (deep) sleep during two rounds of deactivated SCell measurement. A design concept is to trade a relatively long measurement delay for terminal power saving. However, if the deactivated Scell is configured with the L1 measurement, and the L1 measurement usually needs to be performed frequently to achieve an objective of timely handover, the terminal cannot enter the deep sleep.

To resolve the problem, in the Scell measurement method provided in embodiments of this application, in the case 4 in which the measurement of both the L1 frequency (that is, the first frequency) and the L3 frequency (that is, the second frequency) of the first Scell does not require the gap, if the L1 measurement is configured or activated on an SSB frequency layer of the deactivated first Scell, the longest measurement time for the L3 measurement and the L1 measurement may be determined based on a synchronization signal/physical broadcast channel block (SSB) cycle or an SSB-based radio resource management measurement timing configuration (SMTC) cycle of the L1 or the L3, instead of being determined based on the configured MeasCycleScell for the L3. In this way, a delay of the L3 measurement of the deactivated SCell can be greatly reduced.

Optionally, the performance indicator of the L1 measurement is determined based on an SSB cycle of the measurement object, and the performance indicator of the L3 measurement is determined based on an SMTC cycle of the measurement object; or
the performance indicator of the L1 measurement and the performance indicator of the L3 measurement are both determined based on the SSB cycle of the measurement object. SSB cycles of a serving cell and a neighboring cell on which the L1 measurement needs to be performed are always equal.

Optionally, for a certain deactivated SCell frequency, if no gap is required for the configured L1 and L3 measurement, measurement time and relevant performance indicators of the L3 and the L1 are determined based on the SSB.

In the prior art, the performance indicator of the L3 measurement of the deactivated SCell is shown in Table 1, and depends on a value of measCycleSCell. measCycleSCell is configured by a system, and is used for controlling the measurement delay to facilitate the terminal power saving.

TABLE 1
Time cycle

| Discontinuous reception | |
|---|---|
| (Discontinuous Reception, | |
| DRX) cycle (cycle) | T_{PSS/SSS}_{_{—}}_{sync}_{_{—}}ᵢₙₜᵣₐ |
| No DRX | Ceil(5 × Kₚ) × measCycleSCell × CSSFᵢₙₜᵣₐ |
| DRX cycle ≤ 320 ms | Ceil(5 × Kₚ) × max(measCycleSCell, 1.5 × |
| | DRX cycle) × CSSFᵢₙₜᵣₐ |
| DRX cycle > 320 ms | Ceil(5 × Kₚ) × max(measCycleSCell, DRX |
| | cycle) × CSSFᵢₙₜᵣₐ |

Remark: applicable to a deactivated secondary cell group (Secondary Cell Group, SCG) SCell

T_{PSS/SSS_sync_intra} represents same-frequency PSS/SSS (synchronization signal) detection time in a synchronization state. Ceil is a ceil function. Kₚ represents a scaling factor of a to-be-measured SSB frequency that does not require the measurement gap. CSSFᵢₙₜᵣₐ represents a same-frequency carrier-specific scaling factor.

In the Scell measurement method provided in embodiments of this application, for the L3 measurement of the deactivated SCell, the measurement may be performed based on the SSB (instead of based on measCycleSCell), to achieve an objective of reducing the delay of the L3 measurement of the deactivated SCell. The relevant performance indicator thereof may use the SSB of the measurement object to replace measCycleSCell, as shown in Table 2. T_{SSB} is the SSB cycle of the measurement object.

TABLE 2
Time cycle

| DRX cycle | T_{PSS/SSS}_{_{—}}_{sync}_{_{—}}ᵢₙₜᵣₐ |
|---|---|
| No DRX | Ceil(5 × Kₚ) × T_{SSB} × CSSFᵢₙₜᵣₐ |
| DRX cycle ≤ 320 ms | Ceil(5 × Kₚ) × max(T_{SSB}, 1.5 × DRX cycle) × |
| | CSSFᵢₙₜᵣₐ |
| DRX cycle > 320 ms | Ceil(5 × Kₚ) × max(T_{SSB}, DRX cycle) × CSSFᵢₙₜᵣₐ |

Remark: applicable to the deactivated SCG SCell

Optionally, embodiments of this application provide a method for determining an interruption caused by the measurement when the deactivated SCell is simultaneously configured with the L1/L3 measurement.

If for a certain deactivated SCell frequency, when the L1/L3 measurement is simultaneously configured, the performance indicator of the L1 measurement is determined based on the SSB cycle of the measurement object, and the performance indicator of the L3 measurement is determined based on the SMTC cycle of the measurement object, or when the performance indicator of the L1 measurement and the performance indicator of the L3 measurement are both determined based on the SSB cycle of the measurement object, the interruption of the L1/L3 measurement is determined based on the following method.

The L1 measurement and the L3 measurement satisfy at least one of the following.
1) The network is not configured with the measurement cycle of the first Scell, and neither the L1 measurement nor the L3 measurement generates the interruption.

For example, the system is no longer configured with measCycleSCell. In this case, neither the L1 measurement nor the L3 measurement generates the interruption, thereby improving system throughput.
2) The network is configured with the measurement cycle of the first Scell, and neither the L1 measurement nor the L3 measurement generates the interruption.

For example, the system is still configured with measCycleSCell. Because the method described in a or b above is used, the L3 measurement cycle is not based on measCycleSCell. Therefore, even if measCycleSCell is greater than or equal to 640 ms, the L3 measurement does not cause the interruption. In this case, the L1 measurement also does not cause the interruption, thereby improving the system throughput.

In other words, for a certain deactivated SCell frequency, when the L1 and the L3 are simultaneously configured and the measurement does not require the gap, the L1 measurement and the L3 measurement may be performed based on the SSB. Alternatively, the L1 measurement uses the SSB cycle, and the L3 measurement uses the SMTC cycle. In this case, regardless of whether the system is configured with measCycleSCell, because a value of the SSB or the SMTC is less than 640 ms, in this case, it may be required that the L1 measurement and the L3 measurement of the deactivated SCell do not cause the interruption.

FIG. 3 is a schematic flowchart 2 of an Scell measurement method according to an embodiment of this application. The method is applied to a network side device. As shown in FIG. 3, the method includes the following.

Step 301: A network side device sends configuration information to a terminal, where the configuration information includes at least one of the following: a first frequency of a first Scell used for L1 measurement; or a second frequency of the first Scell used for L3 measurement.

The first frequency and the second frequency are respectively associated with a same target physical frequency of the first Scell, and the target physical frequency is simultaneously configured with the L1 measurement and the L3 measurement.

Optionally, the first Scell may include at least one of the following: a deactivated Scell; a dormant Scell; or a specific Scell.

For example, when the first Scell is in a deactivated state or a dormant state, if the same target physical frequency of the first Scell is simultaneously configured with the L1 measurement and the L3 measurement, for the target physical frequency, in embodiments of this application, the L1 is used as the first frequency of the first Scell, the L3 is used as the second frequency of the first Scell, and both the first frequency and the second frequency are associated with the target physical frequency. In other words, the L1 and the L3 are respectively processed as one logical frequency. The terminal performs the L1 measurement on the first frequency and performs the L3 measurement on the second frequency.

Optionally, the configuration information further includes indication information, and the indication information indicates that the first frequency and the second frequency are respectively associated with the target physical frequency.

After receiving the configuration information from the network side device, the terminal performs the L1 measurement on the first frequency of the first Scell and performs the L3 measurement on the second frequency of the first Scell based on the configuration information.

In embodiments of this application, the network side device sends the configuration information to the terminal, where the configuration information includes at least one of the following: the first frequency of the first Scell used for the L1 measurement; or the second frequency of the first Scell used for the L3 measurement. The first frequency and the second frequency are respectively associated with the same target physical frequency of the first Scell. The target physical frequency is simultaneously configured with the L1 measurement and the L3 measurement. That is, the same target physical frequency of the first Scell is simultaneously configured with the L1 measurement and the L3 measurement. For the target physical frequency, the L1 is used as the first frequency of the first Scell, the L3 is used as the second frequency of the first Scell, and both the first frequency and the second frequency are associated with the target physical frequency. In other words, the L1 and the L3 are respectively processed as one logical frequency. The terminal performs the L1 measurement on the first frequency and performs the L3 measurement on the second frequency, thereby implementing the L1 measurement and the L3 measurement on the first SCell on which the L1 measurement and the L3 measurement are simultaneously configured.

Optionally, a performance indicator of the L1 measurement includes a first scaling factor; and/or a performance indicator of the L3 measurement includes a second scaling factor.

Optionally, the first scaling factor and the second scaling factor are determined based on at least one of the following:
the first scaling factor is determined based on a carrier-specific scaling factor CSSF within a gap, and the second scaling factor is determined based on a CSSF outside the gap;
the first scaling factor is determined based on the CSSF outside the gap, and the second scaling factor is determined based on the CSSF within the gap;
the first scaling factor is determined based on the CSSF within the gap, and the second scaling factor is determined based on the CSSF within the gap; or
the first scaling factor is determined based on the CSSF outside the gap, and the second scaling factor is determined based on the CSSF outside the gap.

Optionally, the performance indicator of the L1 measurement is determined based on a synchronization signal/physical broadcast channel block SSB cycle of a measurement object, and the performance indicator of the L3 measurement is determined based on an SSB-based radio resource management measurement timing configuration SMTC cycle of the measurement object.

Alternatively, the performance indicator of the L1 measurement and the performance indicator of the L3 measurement are both determined based on the SSB cycle of the measurement object.

Optionally, the L1 measurement and the L3 measurement satisfy at least one of the following:
a network is not configured with a measurement cycle for the first Scell, and neither the L1 measurement nor the L3 measurement generates an interruption; or
a network is configured with the measurement cycle for the first Scell, and neither the L1 measurement nor the L3 measurement generates the interruption.

Optionally, the method further includes: receiving, by the network side device, capability information sent by the terminal. The capability information includes at least one of the following:
the L1 measurement requires a gap;
the L1 measurement requires a network controlled small gap NCSG;
the L1 measurement does not require a gap;
the L3 measurement requires a gap;
the L3 measurement requires an NCSG; or
the L3 measurement does not require a gap.

Optionally, the capability information occupies one information field, and indicates that the L1 measurement and the L3 measurement simultaneously satisfy any one of the following: requiring the gap, requiring the NCSG, or not requiring the gap.

Alternatively, the capability information occupies two information fields, and respectively indicates whether the L1 measurement and the L3 measurement each require the gap.

Optionally, the method further includes: sending, by the network side device, a measurement request to the terminal, where the measurement request indicates the terminal to perform the L1 measurement and the L3 measurement.

Optionally, the method further includes: receiving, by the network side device, an L1 measurement result and an L3 measurement result reported by the terminal.

Embodiments of this application further provide an Scell measurement method. The method is cooperatively performed by a terminal and a network side device. The method includes the following.

Step 1: A network side device sends configuration information to a terminal, where the configuration information includes at least one of the following: a first frequency of a first Scell used for Layer 1 (L1) measurement; or a second frequency of the first Scell used for Layer 3 (L3) measurement.

The first frequency and the second frequency are respectively associated with a same target physical frequency of the first Scell, and the target physical frequency is simultaneously configured with the L1 measurement and the L3 measurement.

Step 2: The terminal performs the Layer 1 (L1) measurement on the first frequency of the first Scell based on the configuration information.

The terminal performs the Layer 3 (L3) measurement on the second frequency of the first Scell.

The first frequency and the second frequency are respectively associated with the same target physical frequency of the first Scell, and the target physical frequency is simultaneously configured with the L1 measurement and the L3 measurement.

In embodiments of this application, the network side device sends the configuration information to the terminal, where the configuration information includes at least one of the following: the first frequency of the first Scell used for the L1 measurement; or the second frequency of the first Scell used for the L3 measurement. The first frequency and the second frequency are respectively associated with the same target physical frequency of the first Scell. The target physical frequency is simultaneously configured with the L1 measurement and the L3 measurement. That is, the same target physical frequency of the first Scell is simultaneously configured with the L1 measurement and the L3 measurement. For the target physical frequency, the L1 is used as the first frequency of the first Scell, the L3 is used as the second frequency of the first Scell, and both the first frequency and the second frequency are associated with the target physical frequency. In other words, the L1 and the L3 are respectively processed as one logical frequency. The terminal performs the L1 measurement on the first frequency and performs the L3 measurement on the second frequency, thereby implementing the L1 measurement and the L3 measurement on the first SCell on which the L1 measurement and the L3 measurement are simultaneously configured.

The Scell measurement method provided in embodiments of this application may be performed by an Scell measurement apparatus. In embodiments of this application, the Scell measurement apparatus provided in embodiments of this application is described by using an example in which the Scell measurement apparatus performs the Scell measurement method.

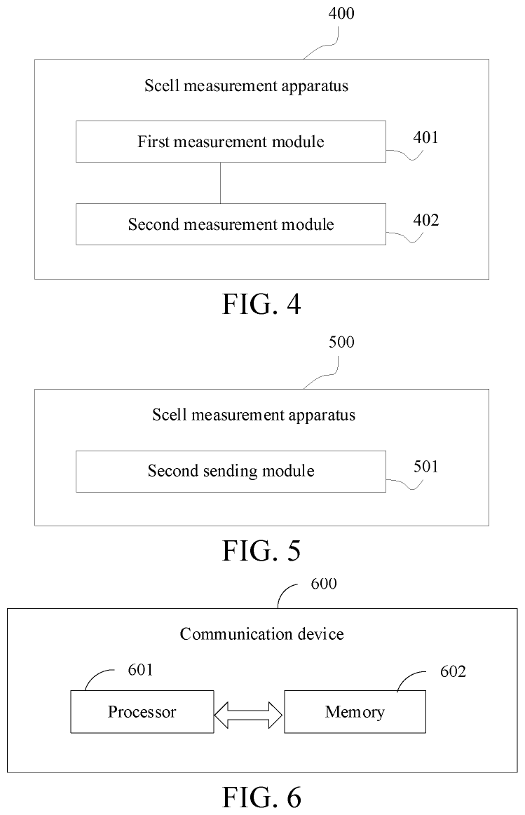

FIG. 4 is a schematic structural diagram 1 of an Scell measurement apparatus according to an embodiment of this application. As shown in FIG. 4, an Scell measurement apparatus 400 is applied to a terminal. The Scell measurement apparatus 400 includes a first measurement module 401 and a second measurement module 402.

The first measurement module 401 is configured to perform L1 measurement on a first frequency of a first Scell.

The second measurement module 402 is configured to perform L3 measurement on a second frequency of the first Scell.

The first frequency and the second frequency are respectively associated with a same target physical frequency of the first Scell, and the target physical frequency is simultaneously configured with the L1 measurement and the L3 measurement.

In embodiments of this application, the same target physical frequency of the first Scell is simultaneously configured with the L1 measurement and the L3 measurement. For the target physical frequency, the L1 is used as the first frequency of the first Scell, the L3 is used as the second frequency of the first Scell, and both the first frequency and the second frequency are associated with the target physical frequency. In other words, the L1 and the L3 are respectively processed as one logical frequency. The terminal performs the L1 measurement on the first frequency and performs the L3 measurement on the second frequency, thereby implementing the L1 measurement and the L3 measurement on the first SCell on which the L1 measurement and the L3 measurement are simultaneously configured.

Optionally, a performance indicator of the L1 measurement includes a first scaling factor; and/or a performance indicator of the L3 measurement includes a second scaling factor.

Optionally, the first scaling factor and the second scaling factor are determined based on at least one of the following:
the first scaling factor is determined based on a carrier-specific scaling factor CSSF within a gap, and the second scaling factor is determined based on a CSSF outside the gap;
the first scaling factor is determined based on the CSSF outside the gap, and the second scaling factor is determined based on the CSSF within the gap;
the first scaling factor is determined based on the CSSF within the gap, and the second scaling factor is determined based on the CSSF within the gap; or
the first scaling factor is determined based on the CSSF outside the gap, and the second scaling factor is determined based on the CSSF outside the gap.

Optionally, the performance indicator of the L1 measurement is determined based on a synchronization signal/physical broadcast channel block SSB cycle of a measurement object, and the performance indicator of the L3 measurement is determined based on an SSB-based radio resource management measurement timing configuration SMTC cycle of the measurement object;
or
the performance indicator of the L1 measurement and the performance indicator of the L3 measurement are both determined based on the SSB cycle of the measurement object.

Optionally, the L1 measurement and the L3 measurement satisfy at least one of the following:
a network is not configured with a measurement cycle for the first Scell, and neither the L1 measurement nor the L3 measurement generates an interruption; or
a network is configured with the measurement cycle for the first Scell, and neither the L1 measurement nor the L3 measurement generates the interruption.

Optionally, the apparatus further includes:
a first sending module, configured to send capability information to the network side device.

The capability information includes at least one of the following:
the L1 measurement requires a gap;
the L1 measurement requires a network controlled small gap NCSG;
the L1 measurement does not require a gap;
the L3 measurement requires a gap;
the L3 measurement requires an NCSG; or
the L3 measurement does not require a gap.

The Scell measurement apparatus in embodiments of this application may be an electronic device, for example, an electronic device having an operating system, or may be a component in an electronic device, such as an integrated circuit or a chip. The electronic device may be a terminal, or may be another device other than the terminal. For example, the terminal may include, but is not limited to, the types of the terminal 11 listed above, and the another device may be a server, a network attached storage (NAS), or the like. This is not specifically limited in embodiments of this application.

The Scell measurement apparatus provided in embodiments of this application can implement the processes implemented in the method embodiments shown in FIG. 2, and achieve the same technical effect. To avoid repetition, details are not described herein again.

FIG. 5 is a schematic structural diagram 2 of an Scell measurement apparatus according to an embodiment of this application. As shown in FIG. 5, an Scell measurement apparatus 500 is applied to a network side device. The Scell measurement apparatus 500 includes:

a second sending module 501, configured to send configuration information to a terminal, where the configuration information includes at least one of the following:

a first frequency of a first Scell used for Layer 1 (L1) measurement; or
a second frequency of the first Scell used for Layer 3 (L3) measurement.

The first frequency and the second frequency are respectively associated with a same target physical frequency of the first Scell, and the target physical frequency is simultaneously configured with the L1 measurement and the L3 measurement.

In embodiments of this application, through sending of the configuration information to the terminal, the configuration information includes at least one of the following: the first frequency of the first Scell used for the L1 measurement; or the second frequency of the first Scell used for the L3 measurement. The first frequency and the second frequency are respectively associated with the same target physical frequency of the first Scell. The target physical frequency is simultaneously configured with the L1 measurement and the L3 measurement. That is, the same target physical frequency of the first Scell is simultaneously configured with the L1 measurement and the L3 measurement. For the target physical frequency, the L1 is used as the first frequency of the first Scell, the L3 is used as the second frequency of the first Scell, and both the first frequency and the second frequency are associated with the target physical frequency. In other words, the L1 and the L3 are respectively processed as one logical frequency. The terminal performs the L1 measurement on the first frequency and performs the L3 measurement on the second frequency, thereby implementing the L1 measurement and the L3 measurement on the first SCell on which the L1 measurement and the L3 measurement are simultaneously configured.

Optionally, the performance indicator of the L1 measurement is determined based on a synchronization signal/physical broadcast channel block SSB cycle of a measurement object, and the performance indicator of the L3 measurement is determined based on an SSB-based radio resource management measurement timing configuration SMTC cycle of the measurement object;
or
the performance indicator of the L1 measurement and the performance indicator of the L3 measurement are both determined based on the SSB cycle of the measurement object.

Optionally, the L1 measurement and the L3 measurement satisfy at least one of the following:
a network is not configured with a measurement cycle for the first Scell, and neither the L1 measurement nor the L3 measurement generates an interruption; or
a network is configured with the measurement cycle for the first Scell, and neither the L1 measurement nor the L3 measurement generates the interruption.

Optionally, the apparatus further includes:
a receiving module, configured to receive capability information sent by the terminal.

The capability information includes at least one of the following:
the L1 measurement requires a gap;
the L1 measurement requires a network controlled small gap NCSG;
the L1 measurement does not require a gap;
the L3 measurement requires a gap;
the L3 measurement requires an NCSG; or
the L3 measurement does not require a gap.

The Scell measurement apparatus in embodiments of this application may be an electronic device, for example, an electronic device having an operating system, or may be a component in an electronic device, such as an integrated circuit or a chip. The electronic device may be a network side device, or may be another device other than the network side device. For example, the network side device may include, but is not limited to, the types of the network side device 12 listed above, and the another device may be a server, a network attached storage (NAS), or the like. This is not specifically limited in embodiments of this application.

The Scell measurement apparatus provided in embodiments of this application can implement the processes implemented in the method embodiments shown in FIG. 3, and achieve the same technical effect. To avoid repetition, details are not described herein again.

An embodiment of this application further provides a communication device. FIG. 6 is a schematic structural diagram of a communication device according to an embodiment of this application. As shown in FIG. 6, a communication device 600 includes a processor 601 and a memory 602. The memory 602 stores a program or instructions executable in the processor 601. For example, when the communication device 600 is a terminal, the program or the instructions, when executed by the processor 601, implement the steps of the foregoing method embodiments shown in FIG. 2, and the same technical effect can be achieved. When the communication device 600 is a network side device, the program or the instructions, when executed by the processor 601, implement the steps in the foregoing method embodiments shown in FIG. 3, and can achieve the same technical effect. To avoid repetition, details are not described herein again.

An embodiment of this application further provides a terminal, including a processor and a communication interface. The communication interface is coupled to the processor. The processor is configured to run a program or instructions, to implement the steps in the method embodiments shown in FIG. 2. The terminal embodiment corresponds to the foregoing method embodiment of the terminal side. The implementation processes and implementations of the foregoing method embodiment are all applicable to the terminal embodiment, and can achieve the same technical effect.

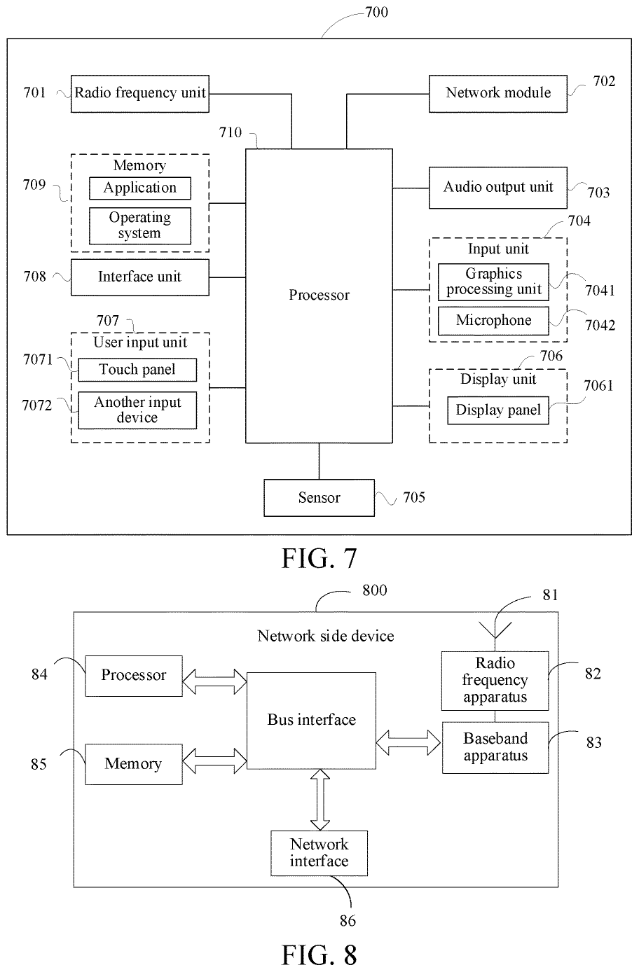

An embodiment of this application further provides a terminal. FIG. 7 is a schematic diagram of a hardware structure of a terminal according to an embodiment of this application. As shown in FIG. 7, a terminal 700 includes, but is not limited to, at least some of components such as a radio frequency unit 701, a network module 702, an audio output unit 703, an input unit 704, a sensor 705, a display unit 706, a user input unit 707, an interface unit 708, a memory 709, and a processor 710.

A person skilled in the art may understand that the terminal 700 may further include a power supply (such as a battery) that supplies power to various components. The power supply may be logically connected to the processor 710 through a power management system, thereby implementing functions such as charging, discharging, and power consumption management through the power management system. The terminal structure shown in FIG. 7 constitutes no limitation on the terminal, and the terminal may include more or fewer components than those shown in the figure, or some merged components, or different component arrangements. Details are not described herein again.

It should be noted that in embodiments of this application, the input unit 704 may include a graphics processing unit (GPU) 7041 and a microphone 7042. The graphics processing unit 7041 processes image data of a static picture or a video obtained by an image capture apparatus (such as a camera) in a video capture mode or an image capture mode. The display unit 706 may include a display panel 7061. The display panel 7061 may be configured in a form such as a liquid crystal display or an organic light-emitting diode. The user input unit 707 includes at least one of a touch panel 7071 or another input device 7072. The touch panel 7071 is also referred to as a touch screen. The touch panel 7071 may include two parts: a touch detection apparatus and a touch controller. The another input device 7072 may include, but is not limited to, a physical keyboard, a function button (such as a volume control button or a power button), a trackball, a mouse, and a joystick. Details are not described herein again.

In embodiments of this application, the radio frequency unit 701 receives downlink data from a network side device, and then may transmit the data to the processor 710 for processing. In addition, the radio frequency unit 701 may send uplink data to the network side device. Generally, the radio frequency unit 701 includes, but is not limited to, an antenna, an amplifier, a transceiver, a coupler, a low noise amplifier, a duplexer, and the like.

The memory 709 may be configured to store a software program or instructions and various data. The memory 709 may mainly include a first storage area for storing a program or instructions and a second storage area for storing data. The first storage area may store an operating system, an application or instructions required for at least one function (such as a sound playback function and an image playback function), and the like. In addition, the memory 709 may include a volatile memory or a non-volatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), or a direct rambus random access memory (Direct Rambus RAM, DRRAM). The memory 709 in embodiments of this application includes, but is not limited to, these and any other suitable types of memories.

The processor 710 may include one or more processing units. Optionally, an application processor and a modem processor are integrated into the processor 710. The application processor mainly processes operations related to an operating system, a user interface, an application, and the like. The modem processor mainly processes a wireless communication signal, such as a baseband processor. It may be understood that the foregoing modem processor may alternatively not be integrated into the processor 710.

The processor 710 is configured to perform L1 measurement on a first frequency of a first Scell, and perform L3 measurement on a second frequency of the first Scell. The first frequency and the second frequency are respectively associated with a same target physical frequency of the first Scell, and the target physical frequency is simultaneously configured with the L1 measurement and the L3 measurement.

In embodiments of this application, the same target physical frequency of the first Scell is simultaneously configured with the L1 measurement and the L3 measurement. For the target physical frequency, the L1 is used as the first frequency of the first Scell, the L3 is used as the second frequency of the first Scell, and both the first frequency and the second frequency are associated with the target physical frequency. In other words, the L1 and the L3 are respectively processed as one logical frequency. The terminal performs the L1 measurement on the first frequency and performs the L3 measurement on the second frequency, thereby implementing the L1 measurement and the L3 measurement on the first SCell on which the L1 measurement and the L3 measurement are simultaneously configured.

It may be understood that for the implementation processes of all implementations mentioned in embodiments, reference may be made to the relevant description in the foregoing method embodiments shown in FIG. 2, and the same or corresponding technical effects can be achieved. To avoid repetition, details are not described herein again.

An embodiment of this application further provides a network side device, including a processor and a communication interface. The communication interface is coupled to the processor. The processor is configured to run a program or instructions, to implement the steps of the method embodiments shown in FIG. 3. The network side device embodiment corresponds to the foregoing method embodiment of the network side device. The implementation processes and implementations of the foregoing method embodiment can be applied to the network side device embodiment, and can achieve the same technical effect.

An embodiment of this application further provides a network side device. FIG. 8 is a schematic diagram of a hardware structure of a network side device according to an embodiment of this application. As shown in FIG. 8, the network side device 800 includes an antenna 81, a radio frequency apparatus 82, a baseband apparatus 83, a processor 84, and a memory 85. The antenna 81 is connected to the radio frequency apparatus 82. In an uplink direction, the radio frequency apparatus 82 receives information through the antenna 81, and sends the received information to the baseband apparatus 83 for processing. In a downlink direction, the baseband apparatus 83 processes to-be-sent information, and sends the processed to-be-sent information to the radio frequency apparatus 82. The radio frequency apparatus 82 processes the received information and then sends the processed received information through the antenna 81.

The method performed by the network side device in the foregoing embodiment may be implemented in the baseband apparatus 83. The baseband apparatus 83 includes a baseband processor.

The baseband apparatus 83 may include, for example, at least one baseband board. The baseband board is provided with a plurality of chips. As shown in FIG. 8, one of the chips is, for example, a baseband processor, and is connected to the memory 85 through a bus interface, to call a program in the memory 85 to perform the operations of the network device shown in the foregoing method embodiments.

The network side device may further include a network interface 86, and the interface is, for example, a common public radio interface (CPRI).

Specifically, the network side device 800 in embodiments of this application further includes: instructions or a program stored in the memory 85 and executable in the processor 84. The processor 84 calls the instructions or the program in the memory 85 to perform the steps of the method embodiments shown in FIG. 3, and achieves the same technical effect. To avoid repetition, details are not described herein.

An embodiment of this application further provides a readable storage medium. The readable storage medium stores a program or instructions. The program or the instructions, when executed by a processor, implement the processes of the foregoing Scell measurement method embodiments, and can achieve the same technical effect. To avoid repetition, details are not described herein again.

The processor is a processor of the terminal in the foregoing embodiments. The readable storage medium includes a computer-readable storage medium, such as a computer read-only memory ROM, a random access memory RAM, a magnetic disk, or an optical disc. In some examples, the readable storage medium may be a non-transient readable storage medium.

An embodiment of this application further provides a chip. The chip includes a processor and a communication interface. The communication interface is coupled to the processor. The processor is configured to run a program or instructions, to implement the processes of the foregoing Scell measurement method embodiments, and can achieve the same technical effect. To avoid repetition, details are not described herein again.

It should be understood that the chip mentioned in this embodiment of this application may further be referred to as a system level chip, a system chip, a chip system, a system on chip, or the like.

An embodiment of this application further provides a computer program/program product. The computer program/program product is stored in a storage medium. The computer program/program product is executed by at least one processor to implement the processes of the foregoing Scell measurement method embodiments, and can achieve the same technical effect. To avoid repetition, details are not described herein again.

An embodiment of this application further provides a wireless communication system, including a terminal and a network side device. The terminal may be configured to perform the steps of the method embodiments shown in FIG. 2, and the network side device may be configured to perform the steps of the method embodiments shown in FIG. 3.

In embodiments of this application, a same target physical frequency of a first Scell is simultaneously configured with L1 measurement and L3 measurement. For the target physical frequency, the L1 is used as a first frequency of the first Scell, the L3 is used as a second frequency of the first Scell, and both the first frequency and the second frequency are associated with the target physical frequency. In other words, the L1 and the L3 are respectively processed as one logical frequency. A terminal performs the L1 measurement on the first frequency and performs the L3 measurement on the second frequency, thereby implementing the L1 measurement and the L3 measurement on the first SCell on which the L1 measurement and the L3 measurement are simultaneously configured.

It should be noted that, a term “include”, “comprise”, or any other variant thereof herein is intended to encompass non-exclusive inclusion, so that a process, a method, an article, or an apparatus including a series of elements not only includes those elements, but also includes another element not listed explicitly, or includes intrinsic elements for the process, the method, the article, or the apparatus. Without any further limitation, an element defined by the phrase “include one . . . ” does not exclude existence of an additional same element in the process, the method, the article, or the apparatus that includes the element. In addition, it should be noted that the scope of the method and the apparatus in the implementations of this application is not limited to function execution in the order shown or discussed and may further include function execution in a substantially simultaneous manner or in the opposite order based on the functions involved. For example, the described method may be performed in an order different from the described order, and various steps may further be added, omitted, or combined. In addition, features described with reference to some examples may be combined in another example.

According to the descriptions of the foregoing implementations, a person skilled in the art may clearly understand that the method in the foregoing embodiments may be implemented by a computer software product with a necessary universal hardware platform, or may certainly be implemented by hardware. The computer software product is stored in a storage medium (such as a ROM, a RAM, a magnetic disk, or an optical disc) and includes several instructions to enable a terminal or a network side device to perform the methods described in embodiments of this application.

Although embodiments of this application are described above with reference to the accompanying drawings, this application is not limited to the foregoing specific implementations. The foregoing specific implementations are illustrative only but not restrictive. With the enlightenment of this application, a person of ordinary skill in the art may make many forms of implementations without departing from the concept of this application and the protection scope of the claims. These implementations fall within the protection of this application.

What is claimed is:

1. A secondary cell (Scell) measurement method, comprising:
performing, by a terminal, Layer 1 (L1) measurement on a first frequency of a first Scell; and
performing, by the terminal, Layer 3 (L3) measurement on a second frequency of the first Scell, wherein
the first frequency and the second frequency are respectively associated with a same target physical frequency of the first Scell, and the target physical frequency is simultaneously configured with the L1 measurement and the L3 measurement.

2. The Scell measurement method according to claim 1, wherein a performance indicator of the L1 measurement comprises a first scaling factor; or a performance indicator of the L3 measurement comprises a second scaling factor; or the performance indicator of the L1 measurement comprises the first scaling factor and the performance indicator of the L3 measurement comprises the second scaling factor.

3. The Scell measurement method according to claim 2, wherein the first scaling factor and the second scaling factor are determined based on at least one of the following:
the first scaling factor is determined based on a carrier-specific scaling factor (CSSF) within a gap, and the second scaling factor is determined based on a CSSF outside the gap;
the first scaling factor is determined based on the CSSF outside the gap, and the second scaling factor is determined based on the CSSF within the gap;
the first scaling factor is determined based on the CSSF within the gap, and the second scaling factor is determined based on the CSSF within the gap; or
the first scaling factor is determined based on the CSSF outside the gap, and the second scaling factor is determined based on the CSSF outside the gap.

4. The Scell measurement method according to claim 3, wherein when the first scaling factor is determined based on the CSSF within the gap, the L1 measurement is used as a candidate object for measurement within a target gap, or
wherein when the first scaling factor is determined based on the CSSF outside the gap, the L1 measurement is used as a candidate object for measurement outside a target gap.

5. The Scell measurement method according to claim 1, wherein a performance indicator of the L1 measurement is determined based on a synchronization signal/physical broadcast channel block (SSB) cycle of a measurement object, and a performance indicator of the L3 measurement is determined based on an SSB-based radio resource management measurement timing configuration (SMTC) cycle of the measurement object;
or
the performance indicator of the L1 measurement and the performance indicator of the L3 measurement are both determined based on the SSB cycle of the measurement object.

6. The Scell measurement method according to claim 5, wherein the L1 measurement and the L3 measurement satisfy at least one of the following:
a network is not configured with a measurement cycle for the first Scell, and neither the L1 measurement nor the L3 measurement generates an interruption; or
a network is configured with the measurement cycle for the first Scell, and neither the L1 measurement nor the L3 measurement generates the interruption.

7. The Scell measurement method according to claim 1, wherein the method further comprises:
sending, by the terminal, capability information to a network side device, wherein
the capability information comprises at least one of the following:
the L1 measurement requires a gap;
the L1 measurement requires a network controlled small gap (NCSG);
the L1 measurement does not require a gap;
the L3 measurement requires a gap;
the L3 measurement requires an NCSG; or
the L3 measurement does not require a gap.

8. The Scell measurement method according to claim 7, wherein the capability information occupies one information field, and indicates that the L1 measurement and the L3 measurement simultaneously satisfy any one of the following: requiring the gap, requiring the NCSG, or not requiring the gap;
or
the capability information occupies two information fields, and respectively indicates whether the L1 measurement and the L3 measurement each require the gap.

9. The Scell measurement method according to claim 1, wherein the method further comprises:
receiving, by the terminal, a measurement request from the network side device, wherein the measurement request indicates the terminal to perform the L1 measurement and the L3 measurement.

10. The Scell measurement method according to claim 1, wherein the method further comprises:
receiving, by the terminal, configuration information from the network side device, wherein the configuration information comprises at least one of the following:
the first frequency used for the L1 measurement; or
the second frequency used for the L3 measurement.

11. The Scell measurement method according to claim 1, wherein the method further comprises:
reporting, by the terminal, an L1 measurement result to the network side device based on the L1 measurement; and
reporting, by the terminal, an L3 measurement result to the network side device based on the L3 measurement.

12. The Scell measurement method according to claim 1, wherein the first Scell comprises at least one of the following: a deactivated Scell; a dormant Scell; or a specific Scell.

13. A secondary cell (Scell) measurement method, comprising:
sending, by a network side device, configuration information to a terminal, wherein the configuration information comprises at least one of the following:
a first frequency of a first Scell used for Layer 1 (L1) measurement; or
a second frequency of the first Scell used for Layer 3 (L3) measurement, wherein
the first frequency and the second frequency are respectively associated with a same target physical frequency of the first Scell, and the target physical frequency is simultaneously configured with the L1 measurement and the L3 measurement.

14. The Scell measurement method according to claim 13, wherein a performance indicator of the L1 measurement comprises a first scaling factor; or a performance indicator of the L3 measurement comprises a second scaling factor; or the performance indicator of the L1 measurement comprises the first scaling factor and the performance indicator of the L3 measurement comprises the second scaling factor.

15. The Scell measurement method according to claim 13, wherein a performance indicator of the L1 measurement is determined based on a synchronization signal/physical broadcast channel block (SSB) cycle of a measurement object, and a performance indicator of the L3 measurement is determined based on an SSB-based radio resource management measurement timing configuration SMTC cycle of the measurement object;
or
the performance indicator of the L1 measurement and the performance indicator of the L3 measurement are both determined based on the SSB cycle of the measurement object.

16. The Scell measurement method according to claim 13, wherein the method further comprises:
receiving, by the network side device, capability information sent by the terminal, wherein
the capability information comprises at least one of the following:
the L1 measurement requires a gap;
the L1 measurement requires a network controlled small gap (NCSG);
the L1 measurement does not require a gap;
the L3 measurement requires a gap;
the L3 measurement requires an NCSG; or
the L3 measurement does not require a gap.

17. The Scell measurement method according to claim 13, wherein the method further comprises:
sending, by the network side device, a measurement request to the terminal, wherein the measurement request indicates the terminal to perform the L1 measurement and the L3 measurement.

18. The Scell measurement method according to claim 13, wherein the method further comprises:
receiving, by the network side device, an L1 measurement result and an L3 measurement result reported by the terminal.

19. A terminal, comprising a processor implemented in hardware and a memory, wherein the memory stores a program or instructions executable by the processor, and the program or the instructions, when executed by the processor, direct the processor to:
perform Layer 1 (L1) measurement on a first frequency of a first Scell; and
perform Layer 3 (L3) measurement on a second frequency of the first Scell, wherein
the first frequency and the second frequency are respectively associated with a same target physical frequency of the first Scell, and the target physical frequency is simultaneously configured with the L1 measurement and the L3 measurement.

20. A network side device, comprising a processor implemented in hardware and a memory, wherein the memory stores a program or instructions executable by the processor, and the program or the instructions, when executed by the processor, direct the processor to perform the Scell measurement method according to claim 13.
